(19) United States
(12) Patent Application Publication
(10) Pub. No.: US 2010/0169832 A1
(43) Pub. Date: Jul. 1, 2010

(54) Floating Hierarchical Menu of Navigation History

(76) Inventor: Fred Faching Chang, Hacienda Heights, CA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/636,449

(22) Filed: Dec. 11, 2009

Related U.S. Application Data
(60) Provisional application No. 61/122,511, filed on Dec. 15, 2008.

(51) Int. Cl. G06F 3/048

(52) U.S. Cl. 715/811; 715/854; 715/823; 715/860

(57) ABSTRACT

A method for enabling access to a history of previously accessed data items includes (a) providing a floating hierarchical menu of navigation history which may alternatively be located at any portion of a main window including a hierarchical tree displaying a plurality of previously accessed data items in response to a first user input, and (b) providing for a second user input to select the hierarchical level of nodes displayed, wherein each such data item is displayed as a node of the tree and each such node may be selected to retrieve the previously accessed data item.

### CROSS REFERENCE TO RELATED APPLICATIONS

This application claims the benefit of U.S. Provisional Patent Application No. 61/122,511 filed Dec. 15, 2008, and entitled “Floating Hierarchical Menu of Navigation History,” the contents of which are incorporated herein by reference.

### BACKGROUND OF THE INVENTION

1. Field of the Invention

The present invention relates to web browser and web pages technologies, and more particularly to a floating hierarchical menu system of navigation history for web pages.

2. Description of Related Art

As described in U.S. Pub. No. 2006/0242557, the contents of which is incorporated herein by reference in its entirety, the Internet provides access to almost infinite amounts of information, but current web technology makes it difficult to navigate through large amounts of data. Web pages are also very difficult to build to be flexible in size and have most of the rich, highly developed features and functionality found in traditional graphical user interfaces (GUIs).

Currently there exists a number of methods and techniques to work around these formatting shortcomings. One standard technique is to simply make web pages completely static or rigid in size.

Users can currently navigate web pages by clicking on links or by scrolling. However, if the web page is large and complex, these mechanisms can be cumbersome. The alternative is to break the web page into smaller chunks, which requires the user to frequently request new pages from the web server; this can potentially be very slow depending on the server and the web connection speed. An alternative to this approach is for the web browser to cache raw unformatted data, for example in XML form, then transform the data as needed into HTML however such transformations can also be slow.

Another approach to improving web page functionality is by use of plug-in technology, essentially extensions to the web browser. An example is Macromedia's Flash product. The drawback to plug-ins is that it uses, non-standard proprietary software that has to be installed and kept up to date on the user's computer, and web pages have to be written to conform to a specific plug-in technology. Plug-ins can also potentially pose security risks.

Another popular navigational approach is hierarchical menus systems based on dynamic HTML (DHTML) where the web page displays menus of links (URLs) organized in hierarchical fashion. These menus can be navigated and displayed just by cursor/pointer movement, commonly referred to as “spring loaded.”

The prior art provides spring loaded DHTML menu systems that can easily fit into any location on a web page, and which smoothly and automatically adjusts in size to fit within the boundaries of as containing web page element. The information for a web-page may be configured to be a set of row elements suitable for use in a standard HTML table structure. The row elements may also have a hierarchical dependency, thereby constituting a menu. Depending on where in that information hierarchy a user has navigated to, a particular subset of row elements are displayed as a web-page in the web-browser.

What is needed is a hierarchical, spring loaded DHTML menu system that can easily implement highly efficient recording on computers so that in order to generate a computer-based recording, a user merely executes a single button-push/keystroke.

### SUMMARY OF THE INVENTION

In one embodiment, the present invention includes a floating hierarchical menu system of navigation history for web pages in which the floating hierarchical menu system can display previously-accessed data items as nodes in a tree or trees and alternatively be located at any portion of a main window. The root node of a tree represents a data item accessed via an address entered by a user, while a child node of the tree represents a data item selected from a parent node of the child node. In an embodiment, data items that were displayed in the same window as their parents have different connectors between their associated nodes than do data items that were displayed in different windows from their parents.

Generally, a computer-implemented method for enabling access to a history of previously accessed data items includes the steps of (a) in response to receiving a first input by a user via an interface device, displaying a hierarchical menu of navigation history within a main window of a graphical user interface accessed by the user, wherein the hierarchical menu floats on the main window to at least partially obstruct the main window or contents thereof, wherein the hierarchical menu displays a listing corresponding to a plurality of previously accessed data items by the user, wherein the listing is visually arranged as a node structure comprising at least one parent node representative of an identifier common to one or more child nodes depending therefrom, wherein the one or more child nodes respectively correspond to the previously accessed data items; and (b) in response to receiving a second input from the user corresponding to a selection of one of the child nodes, retrieving the corresponding previously accessed data item.

The interface device may be a mouse, a touch pad, a trackball, or any suitable interface device, wherein the interface device includes a first and second button. The first input may be actuation of the first button on the interface device and the second input may be actuation of the second button on the interface device. The at least one parent node may be configured to be expanded or collapsed to reveal or hide, respectively, the one or more child nodes by actuation of the second button of the interface device when a pointer icon of the user interface is situated on the at least one parent node. Each child node may be highlighted when a pointer icon of the user interface is moved over each child node. The child node may also be highlighted upon selection thereof. The retrieved previously accessed data item may be displayed in the main window of the graphical user interface. The previously accessed data item may be (a) one or more web page addresses; (b) one or more pages from content having multiple pages; and (c) one or more issued commands. The aforementioned aspects may be embodied in the form of instructions stored on a computer-readable medium.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 shows a general screenshot for a software program having a graphical user interface (GUI) capability that includes a navigation mechanism according to a first embodiment of the present invention;

FIG. 2 shows the floating menu buttons according to the first embodiment of the present invention;

FIG. 3 shows the navigation pane including a history item according to the first embodiment of the present invention; and

FIG. 4 shows a general screenshot for a software program having a graphical user interface (GUI) capability that includes a floating hierarchical menu of navigation history according to a second embodiment of the present invention.

### DETAILED DESCRIPTION OF THE INVENTION

The present invention will now be described with reference to the accompanying figures. It is to be understood that the specific system illustrated in the attached figures and described in the following specification is simply an exemplary embodiment of the present invention. Hence, specific dimensions and other physical characteristics related to the embodiments disclosed herein are not to be considered as limiting.

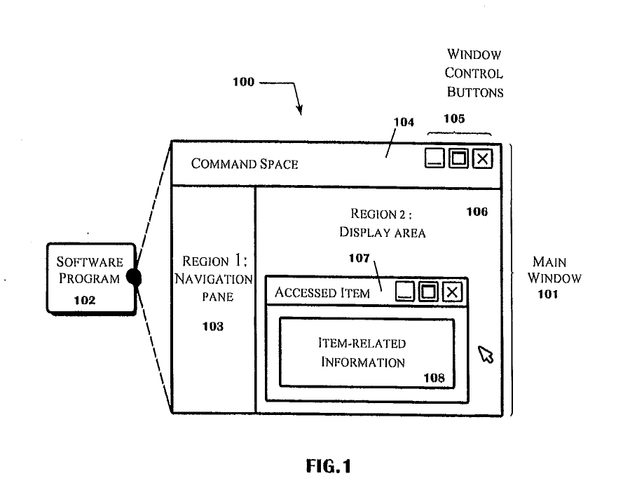

FIG. 1 shows a general screenshot for a software program having a graphical user interface (GUI) capability that includes a navigation mechanism according to a first embodiment of the present invention. In general, screenshot 100, a software program 102, as represented by its main window 101, is illustrated in a navigational or other mode in which an item (e.g., an entity, a file, an object, another data structure, etc.) can be accessed. A first region, or navigation pane 103, includes a listing of entries (not explicitly shown in FIG. 1). Each listed entry represents an item that can be accessed or otherwise interacted with through the navigational mechanism of software program 102.

In general screenshot 100, the main window 101 of software program 102 includes a command space 104. The command space 104 may include a title bar, a menu area, and/or a tool bar, and so forth. Typically, a menu area offers drop-down menus, and a tool bar includes buttons that may be activated by a user to cause software program 102 to perform various actions as represented by the tool bar buttons. The command space 104 of main window 101 may also include standard window control buttons 105 (e.g., those buttons that are determined by an operating system on which software program 102 is running). As illustrated, the window control buttons 105 include, from left to right, a minimization button, a maximization button, and a closing or termination button.

In the illustrated navigation or other item-interaction mode, the main window 101 of software program 102 includes first region 103 that facilitates navigation. This first region 103 includes a pane or sub-window of main window 101. The navigation pane 103 includes a listing of entries (not explicitly shown in FIG. 1) with each entry allowing the user to interact with a represented item via a GUI as shown in general screenshot 100. Hence, the illustrated navigation pane 103 is an example of a navigation mechanism.

In a described navigational implementation, activation of an entry that is listed within navigation pane 103 causes some aspect of the item represented by the activated entry to be displayed in a second region 106 of main window 101. The second region is termed display area 106. As illustrated, item-related information 108 of the activated item is displayed within an accessed item sub-window 107. Item-related information 108 may be, for example, actual contents of the item (e.g., data of a database object, text of a word processing document, etc.), properties information about the item, a description of items that are related to the activated item, accessing or other history of the item, and so forth.

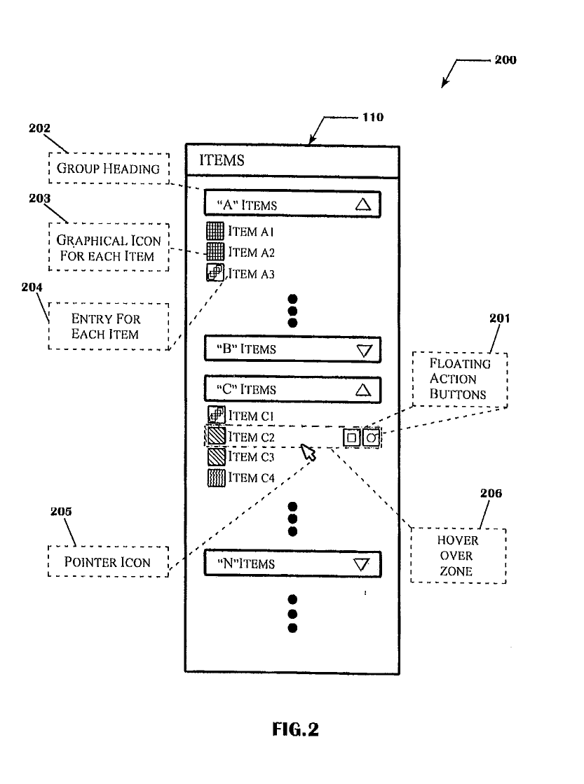

Although navigation pane 103 is illustrated as being displayed vertically, it may alternatively be organized horizontally, or in any other suitable format. Furthermore, navigation pane 103 may alternatively be located at a different portion of main window 101 or in another window that is separate therefrom. Additional example interaction mechanisms, as well as example item-entry listings, are described herein below with particular reference to FIG. 2 in the section entitled “Floating Action Buttons” (i.e., 201).

Although floating menu buttons are described herein primarily in terms of being part of a navigation mechanism of a navigation pane 103, floating menu buttons are not to be construed as being limited as such. For example, floating menu buttons may be utilized in conjunction with software features besides navigation. Such other features include, but are not limited to, word processing features, spreadsheet features, gaming features, other artistic and/or entertainment program features, educational program features, and so forth. For instance, if a word processing program has enabled hover over zones, then locating a pointer over a table may precipitate the presentation of floating action buttons relevant to formatting a table. If a game program has enabled hover over zones, locating a pointer over a tangible object may cause floating action buttons to be presented that enable manipulation of the tangible object. As these examples indicate, floating action buttons may be utilized at any part of a general screen or main window and need not be limited to a particular region.

Although the accompanying figures and the description herein that references them may illustrate and pertain to specific implementations (e.g., in which a region actually is or appears to be represented specifically as a pane, a sub-window, or a separate window, or a portion thereof), it should be understood that graphical elements or regions can be alternatively implemented as a different pane, a sub-window, a separate window, etc. or a combination thereof.

FIG. 2 is an example of floating action buttons 201 being presented with regard to a hover over zone 206 in a navigation environment 200. Navigation environment 200 includes a navigation pane 110. Navigation pane 110 includes one or more lists of entries for items. In a described implementation, the items comprise database objects that are listed in groups. Alternatively, however, the items may comprise any software or logical construct, and navigation pane 110 may be organized in a manner other than a listing or a group of listings.

As illustrated, navigation pane 110 includes “N” groups of items. These “N” groups include the “A” items, the “B” items, the “C” items . . . the “N” items in a vertical listing from top to bottom. Navigation pane 110 may also include other, e.g., navigational-related features, icons, and/or information.

FIG. 2 includes six (6) explanatory annotations 201-205 that are indicated by rectangles formed from medium dashed lines. These annotations 201-205 are not usually actually displayed onscreen; however, they may be displayed (e.g., as a contextual help balloon popup or similar). Although not explicitly shown, navigation pane 110 may include window/sub-window and/or window pane type controls. For example, navigation pane 110 may include a horizontal and/or a vertical scroll bar; it may also include closing, minimizing, etc. buttons. Furthermore, navigation pane 110 may include a pane-style sliding mechanism for changing the width (and/or height) of the visible pane portion.

As illustrated in FIG. 2 at annotation 202, each group of items is listed under a group heading 202. Each group heading 202 includes a collapsing icon or an expansion icon. The “A” and “C” groups have items thereof displayed, so their group headings 202 include a collapsing icon that can be activated to hide their items. The “B” and “N” groups do not have any of their items displayed, so their group headings 202 include an expansion icon that can be activated to reveal their items.

As indicated at annotation 204, each item that is displayed has a corresponding item entry 204 under its associated group heading 202. Items may be associated with groups in a variety of manners and for a variety of reasons. Each item may be associated with more than one group. Items may also be associated with a miscellaneous or an un-assigned group. By way of example only, groups may be separated or segmented by item type, item functionality, item creator, item relationship, and so forth. The grouping may optionally be user-selectable. In an example database implementation, the “A” Items group may be for tables, the “B” Items group may be for queries, the “C” Items group may be for reports, and so forth.

As indicated at annotation 203, a graphical item icon 203 is included as part of the displayed entry listing for each item. In an example implementation, there is a respective type of item icon 203 corresponding to each respective type of item. As indicated at annotation 205, an example pointer icon 205 is also displayed. The example pointer icon 205 includes an arrow in navigation environment 200, but it is to be understood that pointer icons may be realized in other shapes.

As indicated at annotation 206, a hover over zone exists around the entry for “Item C2.” Hover over zone 206 is indicated by the short dashed lines forming the rectangle around the entry for “Item C2”. These short dashed lines are not usually actually displayed onscreen. However, the short dashed lines or another highlighting technique (e.g., inverse video, color change, luminosity change, etc.) may be implemented when a pointer icon 205 enters and thereby engages a hover over zone 206.

As indicated at annotation 201, one or more floating action buttons 201 are presented proximate to pointer icon 205 and/or hover over zone 206. In operation, a UI component establishes a hover over zone 206 proximate to (e.g., fully or partially around) a UI element of interest.

As illustrated, the UI element of interest is each listed item entry 204. When a pointer icon 205 enters hover over zone 206, hover over zone 206 is engaged and floating action buttons 201 are presented. Floating action buttons 201 may be presented (e.g., displayed) fully or partially within hover over zone 206, or floating action buttons 201 may be presented (e.g., displayed) outside of hover over zone 206.

Different types of action buttons may be implemented as floating action buttons 201. For example, floating action buttons 201 may be realized as (i) action buttons that provide a single predetermined action when activated, (ii) so-called split action buttons that can provide a single predetermined “primary” action when a first portion is activated or can produce a pop-up menu with action options when an arrow or similar second portion of the action button is activated, (iii) some other toolbar button metaphor, (iv) some combination thereof, etc.

In order to provide convenience to the user, floating action buttons 201 are presented relatively close to pointer icon 205. This can typically be accomplished by displaying floating action buttons 201 at least partially within hover over zone 206. In fact, in one implementation, as illustrated in FIG. 2, floating action buttons 201 are displayed within the associated hover over zone 206. If a portion of the text of item entry 204 is obscured by floating action buttons 201, ellipses can be added and/or the complete text of item entry 204 can be displayed in a bubble above or below hover over zone 206 and/or floating action buttons 201 (or otherwise proximate to item entry 204).

In a described implementation, floating action buttons 201 are presented onscreen so long as pointer icon 205 remains within hover over zone 206. When the pointer icon 205 is moved outside of hover over zone 206, floating action buttons 201 are removed from the screen. While floating action buttons 201 are displayed, pointer icon 205 can be moved by the user to an action button of floating action buttons 201. Activation of an action button from among the one or more floating action buttons 201 causes an action corresponding to the activated action button to be implemented.

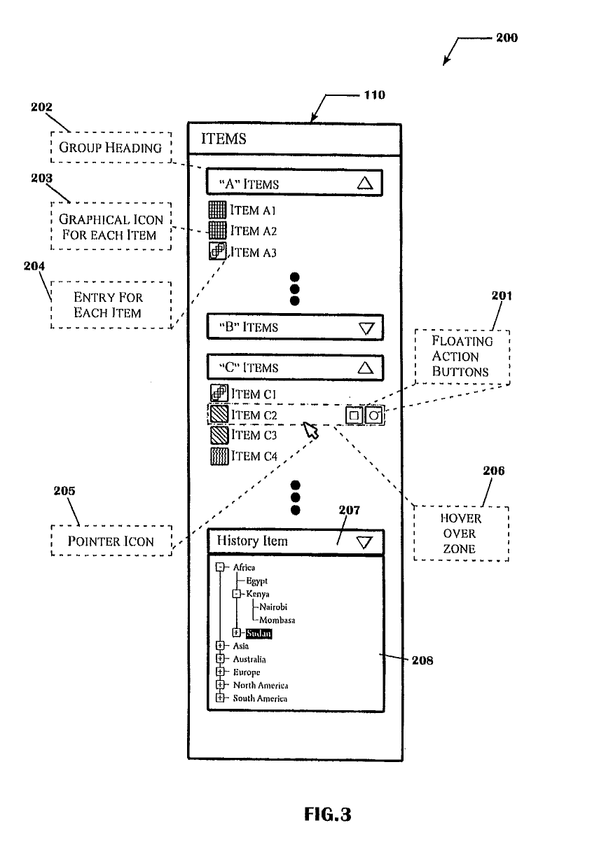

In a described implementation, drop-down menus or a tool bar includes buttons that may be activated by a user to cause software program 102 to perform various actions. In addition, the navigation pane 103 includes a listing of entries (not explicitly shown in FIG. 1) with each entry empowering the user to interact with a represented item via a GUI as shown in general screenshot 100. Although floating menu buttons are described above primarily in terms of being part of a navigation mechanism of a navigation pane 103, floating menu buttons are not to be construed as being limited as such. Since the user frequently access the same pages repeatedly, especially web pages that the user has recently used, the browser keeps track of the web pages that the user has previously accessed using a technique known as a history. A special activation procedure (e.g., right-click) is actuating the display of the floating menu buttons on the screen. Simultaneously, the navigation pane 110 includes a history item 207 as shown in FIG. 3. The group heading, history item 207, also includes a collapsing icon or an expansion icon. When manipulating a GUI with the special (e.g., left-clicking on the history item 207) activation procedure, the history item 207 has previously-accessed data items as nodes in a tree or trees displayed. In other words, the history item 207 displays at least one tree view of the history of web pages accessed. Especially, the previously-accessed data items as nodes in a tree or trees displayed are hierarchy data items. The hierarchy data items structure completely keeps track of the web pages that the user has previously accessed. The root node of a tree represents a data item accessed via an address entered by a user, while a child node of a tree represents a data item selected from a parent node of the child node. In this embodiment, data items that were displayed in the same window as their parents have different connectors between their associated nodes than do data items that were displayed in different windows from their parents. When the pointer icon 205 is moved on each data item, the corresponding data item is highlighted. When the user selects the highlighted data item, the browser retrieves and displays a previously-accessed page.

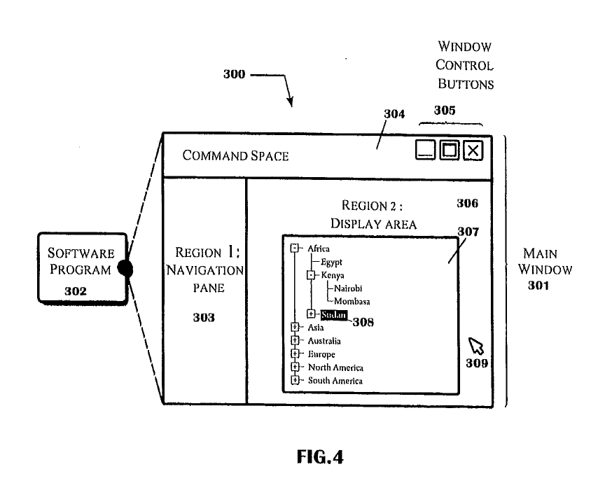

FIG. 4 shows a general screenshot 300 for a software program 302 having a graphical user interface (GUI) capability that includes a navigation mechanism according to a second embodiment of the present invention. In general screenshot 300, a software program 302, as represented by its main window 301, is illustrated in a navigational or other mode in which an item (e.g., an entity, a file, an object, another data structure, etc.) can be accessed. A first region, or navigation pane 303, includes a listing of entries (not explicitly shown in FIG. 4). Each listed entry represents an item that can be accessed or otherwise interacted with through the navigational mechanism of software program 302.

In general screenshot 300, the main window 301 of software program 302 includes a command space 304. The command space 304 may include a title bar, a menu area, and/or a tool bar, and so forth. Typically, a menu area offers drop-down menus, and a tool bar includes buttons that may be activated by a user to cause software program 302 to perform various actions as represented by the tool bar buttons. The command space 304 of main window 301 may also include standard window control buttons 305 (e.g., those buttons that are determined by an operating system on which software program 302 is running). As illustrated, the window control buttons 305 include, from left to right, a minimization button, a maximization button, and a closing or termination button.

In the illustrated navigation or other item-interaction mode, the main window 301 of software program 302 includes a first region 303 that facilitates navigation (e.g., navigation pane 303). This first region includes a pane or sub-window of main window 301. The navigation pane 303 includes a listing of entries (not explicitly shown in FIG. 4) with each entry empowering the user to interact with a represented item via a GUI as shown in general screenshot 300. Hence, the illustrated navigation pane 303 is an example of a navigation mechanism.

In a described navigational implementation, activation of an entry that is listed within navigation pane 303 causes some aspect of the item represented by the activated entry to be displayed in a second region 306 of main window 301. The second region is termed display area 306. As illustrated, a special activation procedure (e.g., right-click) is actuating the display of the floating hierarchical menu of navigation history 307 on the screen. Simultaneously, the floating hierarchical menu of navigation history 307 includes previously-accessed data items as nodes in a tree or trees displayed. If the node has a child node or child nodes, the nodes in a tree or trees can be expanded or collapsed by clicking the parent node or the parent nodes. When manipulating a GUI with the special activation procedure (e.g., left-clicking on the parent node or the parent nodes), the previously-accessed data items as nodes in a tree or trees are displayed. In other words, the floating hierarchical menu of navigation history 307 displays at least one tree view of the history of web pages accessed. Especially, the previously-accessed data items as nodes in a tree or trees displayed are hierarchy data items. The hierarchy data items structure completely keeps track of the web pages that the user has previously accessed. The root node of a tree represents a data item accessed via an address entered by a user, while a child node of a tree represents a data item selected from a parent node of the child node. In this embodiment, data items that were displayed in the same window as their parents have different connectors between their associated nodes than do data items that were displayed in different windows from their parents. When the pointer icon 309 is moved on each data item, the corresponding data item is highlighted. When the user selects the highlighted data item, the browser retrieves and displays a previously-accessed page. The selecting action could be that a user employing a mouse to maneuver a pointer icon 309, left-clicks the mouse. In addition, the floating hierarchical menu of navigation history 307 may be utilized at any part of a general screen or main window 301 and need not be limited to a particular region.

Although the floating hierarchical menu of navigation history 307 is illustrated as being displayed vertically, it may alternatively be organized horizontally, or in any other suitable format. Furthermore, the floating hierarchical menu of navigation history 307 may alternatively be located at a different portion of main window 301 or in another window that is separate therefrom.

In a described implementation, the display of the floating hierarchical menu of navigation history 307 is activated with a standard activation mechanism or procedure. For example, a user employing a mouse to maneuver a pointer icon 309 may right-click the mouse. However, the floating hierarchical menu of navigation history 307 may also be activated with a non-standard or special activation mechanism or procedure. For example, with a pointer-oriented approach, instead of or in addition to right-clicking, a special activation may be enabled or accomplished with, for example, clicking a third or other special mouse button, simultaneously pressing a key and a mouse button, and so forth. When manipulating a GUI with a key-oriented approach, a special activation may be enabled or accomplished with, for example, the “Alt” key, a function key, a “Shift+Enter” keyboard combination, any other key or key combination that is so designated, and so forth.

Accordingly, it can be seen that the present invention provides a floating hierarchical menu system of navigation history for web pages that when a user employing a mouse to maneuver a pointer icon right-clicks a mouse, a floating hierarchical menu of navigation history may alternatively be displayed on a main window and located at any portion of a main window including a hierarchical tree displaying a plurality of previously accessed data items.

The methods and systems described herein may be deployed in part or in whole through a machine that executes computer software (e.g., the software program 102), program codes, and/or instructions on a processor. The processor may be part of a server, client, network infrastructure, mobile computing platform, stationary computing platform, or other computing platform. The processor may be communicatively connected to the Internet or any other distributed communications network via a wired or wireless interface. The processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The invention claimed is:

1. A computer-implemented method for enabling access to a history of previously accessed data items, the method comprising the steps of:
(a) in response to receiving a first input by a user via an interface device, displaying a hierarchical menu of navigation history within a main window of a graphical user interface accessed by the user, wherein the hierarchical menu floats on the main window to at least partially obstruct the main window or contents thereof, wherein the hierarchical menu displays a listing corresponding to a plurality of previously accessed data items by the user, wherein the listing is visually arranged as a node structure comprising at least one parent node representative of an identifier common to one or more child nodes depending therefrom, wherein the one or more child nodes respectively correspond to the previously accessed data items; and
(b) in response to receiving a second input from the user corresponding to a selection of one of the child nodes, retrieving the corresponding previously accessed data item.

2. The method of claim 1, wherein the interface device is a mouse, a touch pad, or a trackball, wherein the interface device includes a first and second button.

3. The method of claim 2, wherein the first input is actuation of the first button on the interface device, and wherein the second input is actuation of the second button on the interface device.

4. The method of claim 3, wherein the at least one parent node is configured to be expanded or collapsed to reveal or hide, respectively, the one or more child nodes by actuation of the second button of the interface device when a pointer icon of the user interface is situated on the at least one parent node.

5. The method of claim 4, wherein each child node is highlighted when a pointer icon of the user interface is moved over each child node.

6. The method of claim 5, wherein the child node is highlighted upon selection thereof.

7. The method of claim 4, further comprising the step of displaying the retrieved previously accessed data item in the main window of the graphical user interface.

8. The method of claim 7, wherein the previously accessed data item is selected from the list consisting of:
(a) one or more web page addresses;
(b) one or more pages from content having multiple pages; and
(c) one or more issued commands.

9. A computer readable medium having stored thereon instructions which, when executed by a processor of a computer, causes the processor to:
(a) in response to receiving a first input by a user via an interface device, displaying a hierarchical menu of navigation history within a main window of a graphical user interface accessed by the user, wherein the hierarchical menu floats on the main window to at least partially obstruct the main window or contents thereof, wherein the hierarchical menu displays a listing corresponding to a plurality of previously accessed data items by the user, wherein the listing is visually arranged as a node structure comprising at least one parent node representative of an identifier common to one or more child nodes depending therefrom, wherein the one or more child nodes respectively correspond to the previously accessed data items; and
(b) in response to receiving a second input from the user corresponding to a selection of one of the child nodes, retrieving the corresponding previously accessed data item.

10. The computer readable medium of claim 9, wherein the interface device is a mouse, a touch pad, or a trackball, wherein the interface device includes a first and second button.

11. The computer readable medium of claim 10, wherein the first input is actuation of the first button on the interface device, and wherein the second input is actuation of the second button on the interface device.

12. The computer readable medium of claim 11, wherein the instructions further cause the processor to expand or collapse to reveal or hide, respectively, the one or more child nodes upon actuation of the second button of the interface device when a pointer icon of the user interface is situated on the at least one parent node.

13. The computer readable medium of claim 12, wherein the instructions further cause the processor to highlight each child node when a pointer icon of the user interface is moved over each child node.

14. The computer readable medium of claim 13, wherein the instructions further cause the processor to highlight each child node upon selection thereof.

15. The computer readable medium of claim 12, wherein the instructions further cause the processor to display the retrieved previously accessed data item in the main window of the graphical user interface.

16. The computer readable medium of claim 15, wherein the previously accessed data item is selected from the list consisting of:
(a) one or more web page addresses;
(b) one or more pages from content having multiple pages; and
(c) one or more issued commands.
